(19) United States
(12) Patent Application Publication
(10) Pub. No.: US 2016/0244304 A1
(43) Pub. Date: Aug. 25, 2016

(54) Crane with Automatic Adjustable Tightening Mechanism

(71) Applicants: Ronen Gomani, Tsfat (IL); Timor Shefi, Tsfat (IL); Itamar Goeta, Kiryat Gat (IL)

(72) Inventors: Ronen Gomani, Tsfat (IL); Timor Shefi, Tsfat (IL); Itamar Goeta, Kiryat Gat (IL)

(21) Appl. No.: 14/629,565

(22) Filed: Feb. 24, 2015

(51) Int. Cl. B66C 23/20

(52) U.S. Cl. CPC B66C 23/201

(57) ABSTRACT

A hoisting crane that comprises a male shaft, a female shaft, a locking shaft, a tightening spring, a hoisting arm, a pressure arm, a top shoe, a bottom shoe, a top bearing, and a bottom bearing. The crane is portable and collapsible and is equipped with an automatic adjusting tightening mechanism that fixes and secures the crane to the work room floor and ceiling using a spring and in a way that the greater the load on the crane, the more the pressure arm increases the tightening force that the crane applies to the work room floor and ceiling.

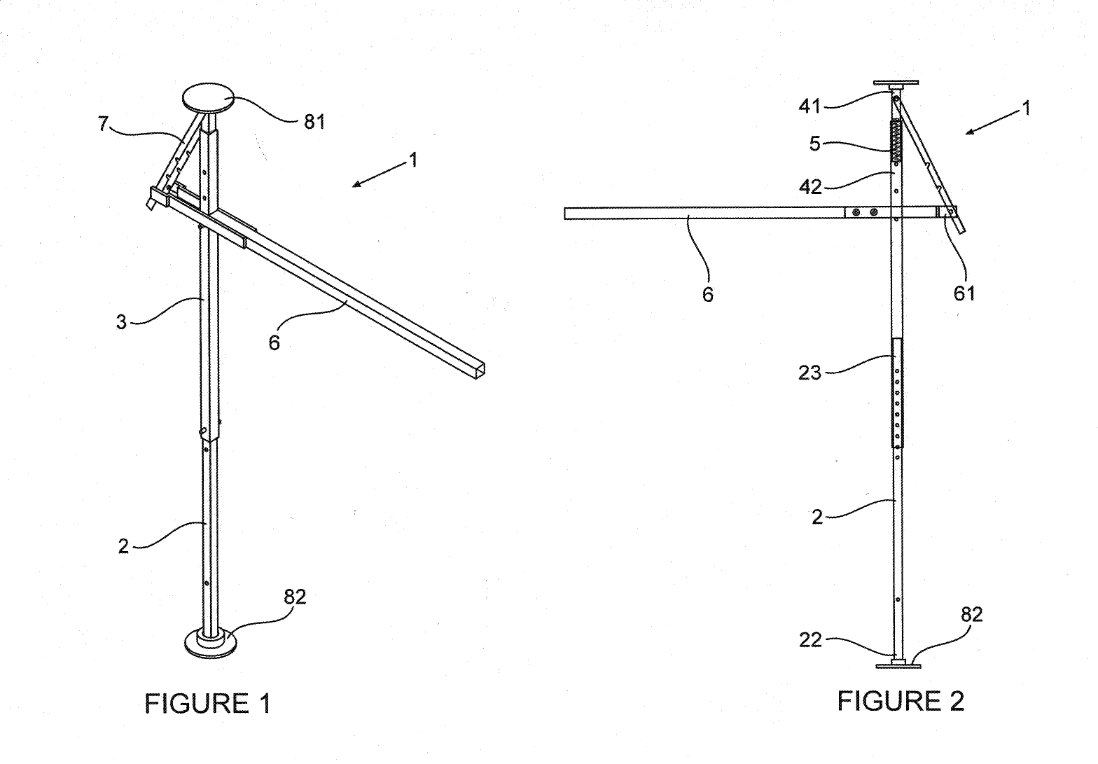

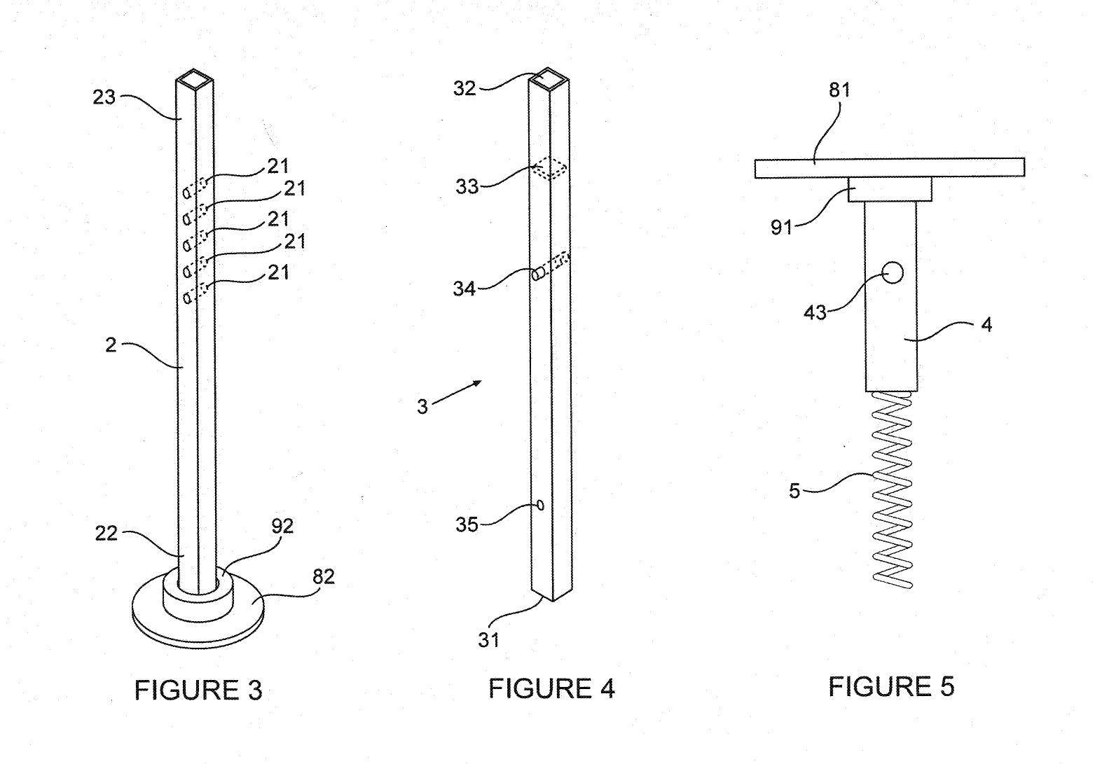

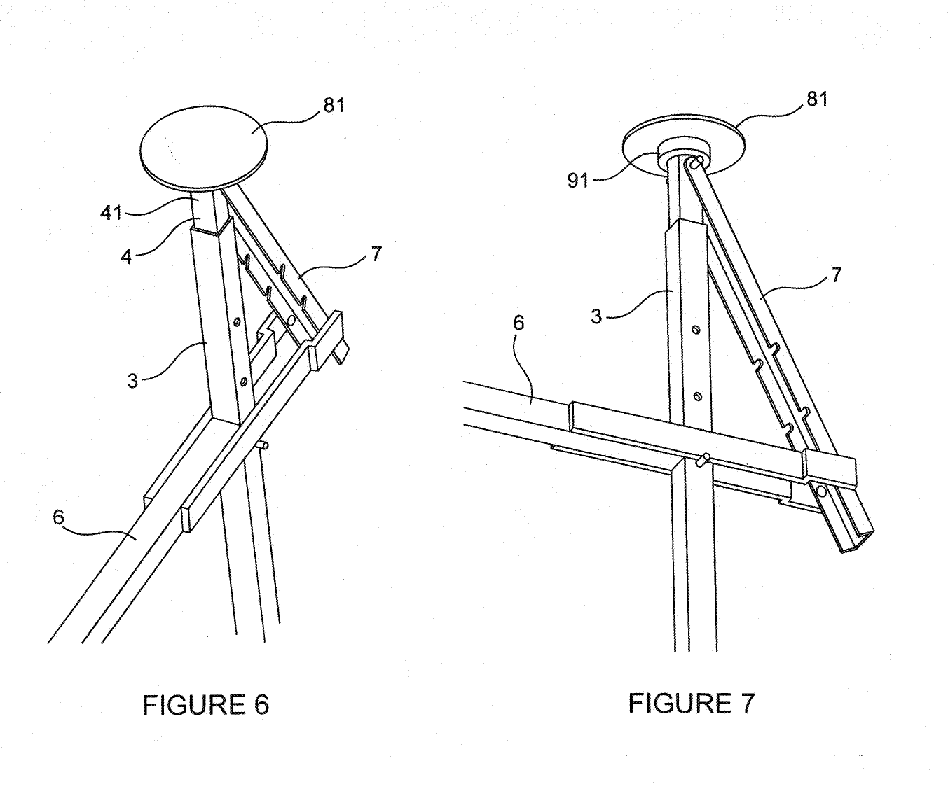

### TECHNICAL FIELD

The present invention refers to a portable and collapsible crane that can be secured tightly to the ceiling and floor of the work site using a spring to and a pressure arm such that the greater the load on the crane's hoisting arm, the tighter the crane is fixed to the ceiling and floor.

### BACKGROUND ART

It is often necessary to use a crane to lift and move loads in buildings, production floors, rooms, and other such spaces (hereinafter “work room”). It is customary to fix such cranes to the work room floor and ceiling by drilling holes in the floor and ceiling and securing the crane with bolts or screws. When the job performed in the said work room is temporary and short term and of a nature that requires the use of a crane, drilling holes in the work room ceiling and floor obviously poses an aesthetic problem and sometimes even a safety risk. In addition, it is unsafe to use cranes that are fixed to the ceiling and floor by means of a spring, since when heavy loads are hoisted, the tightening force of the spring may be insufficient to secure the crane to the work room ceiling and floor. The present invention offers a good and effective solution to the abovementioned problems.

### DESCRIPTION OF THE DRAWINGS

The intention of the drawings attached to the application is not to limit the scope of the invention and its application.

The drawings are intended only to illustrate the invention and they constitute only one of its many possible implementations.

Drawing No. 1 depicts the hoisting crane (1) in perspective.

Drawing No. 2 presents a side-view cross section of the hoisting crane (1).

Drawing No. 3 depicts the male shaft (2), the bottom bearing (92), and the bottom shoe (82).

Drawing No. 4 depicts the female shaft (3).

Drawing No. 5 depicts the locking shaft (4), the spring (5), the top bearing (91), and the top shoe (81).

Drawings Nos. 6 and 7 depict the upper part of the hoisting crane (1), without the bearings.

### THE INVENTION

The main objective of the present invention is to provide a portable and collapsible hoisting crane that includes an automatic adjustable tightening mechanism that fixes and secures the crane to the work room floor and ceiling by means of a spring and a pressure arm. The said mechanism is designed so that the heavier the load on the crane, the tighter the crane is fixed to the floor and ceiling of the work room. Thus, the crane is fixed and secured to the ceiling and floor with a force that corresponds to the weight of the load on the crane at any given time.

The hoisting crane (1), subject of the present invention, is depicted in general in Drawings Nos. 1 and 2, and it comprises a male shaft (2), a female shaft (3), a locking shaft (4), a tightening spring (5), a hoisting arm (6), a pressure arm (7), a top shoe (81), a bottom shoe (82), a top bearing (91), and a bottom bearing (92). The components of the crane (1) can and should be made of rigid, strong, and light materials.

The male shaft (2) is, in general, a long rod with several holes (21) in its upper end. The bottom (22) of the male shaft (2) is attached to the bottom bearing (92), and the bottom bearing (92) is attached to the bottom shoe (82) in a way that enables the male shaft (2) to rotate around its axis while the bottom shoe (82) remains fixed and does not rotate. Drawing No. 3 depicts the male shaft (2), which is attached to the bottom bearing (92), which in turn is attached to the bottom shoe (82).

The female shaft (3) is, in general, a long, hollow rod with a top opening (32) and a bottom opening (31) through which the male shaft (2) may be inserted into the female shaft (3). The female shaft (3) has an internal stopper in its upper part, which may be an internal protrusion (33), an external support means, which may be an external protrusion (34), and a locking hole (35) in its bottom part. Drawing No. 4 depicts the female shaft (3) with the abovementioned components.

The locking shaft (4) is a relatively short rod. The top end (41) of the locking shaft (4) is attached to the top bearing (91), which in turn is attached to the top shoe (81) in such a way that enables the locking shaft (4) to rotate around its axis while the top shoe (81) remains fixed and does not rotate. The bottom end (42) of the locking shaft (4) is attached to a spring (5), as depicted in Drawing No. 5.

The hoisting arm (6) is a long rod and the pressure arm (7) is a relatively short rod, as depicted in the drawings.

Assembly of the system (1) components: The locking shaft (4) is inserted into the female shaft (3) through the top opening (32) until the spring (5) is stopped by the internal protrusion stopper (33). Next, the upper end (23) of the male shaft (2) is inserted into the female shaft (3) through the bottom opening (31) until the top shoe (81) is tightly secured against the ceiling and the bottom shoe (82) is tightly secured against the floor. Downward force is now exerted on the male shaft and upward force is exerted on the female shaft so that the spring (5) is sufficiently compressed. A locking pin is inserted through the locking hole (35) in the female shaft (3) and into a corresponding hole (21) in the male shaft (2). The male shaft (2) and female shaft (3) are now fixed to the floor and ceiling. The upper part of the pressure arm (7) is then attached by means of an axial joint to the rear part (61) of the hoisting arm (6). The said axial joint may be any kind of a variety of axial joints, such as a pm, and so on Finally, the hoisting arm (6) is positioned on the external support protrusion (34) on the female shaft (3) and the crane is ready for use.

Fixing and tightening of the hoisting crane (1): When a load is mounted on the hoisting arm (6), a vertical, downward force acts on the external support protrusion (34) on the female shaft (3) that tightens the bottom shoe (82) to the floor and at the same time a vertical, upward force act on the pressure arm (7) that causes tightening of the top shoe (81) to the ceiling. Thus, the greater the load on the crane, the tighter the crane is fixed to the work room ceiling and floor. Thanks to the special structure of the hoisting crane (1), subject of the present patent application, the more weight there is on the crane, the tighter the crane is fixed to the work room ceiling and floor, and obviously, the heavier the load on the hoisting crane (1), the greater the force required to secure the crane so as to prevent it from falling over or tilting sideways. Drawings Nos. 6 and 7 depict the upper part of the hoisting crane (1).

According to the above explanation, the locking shaft (4) is inserted into the upper part of the female shaft (3). The invention may, however, also be implemented such that the locking shaft (4) is inserted over the female shaft (4) in such a way that the spring (5) is stopped by some external stopper such as an external stopping protrusion. In addition, the bearings (91) (92) may be positioned in different locations on both the locking shaft (4) and the male shaft (2), in a way that permits horizontal rotation of the hoisting arm (6) without rotating the shoes (81) (82).

The hoisting crane (1), subject of the present invention, is relatively light weight, collapsible and portable, and can be easily transported in the trunk of a standard vehicle without taking up much space. It can be assemble easily and quickly in the work room wherever it is needed, without drilling holes in the work room floor or ceiling, and it can be secured and tightened easily, with a tightening force that changes according to the load on the hoisting crane (1) itself.

What is claimed is:

1. A hoisting crane that includes an automatic adjustable tightening mechanism that comprises a male shaft, a female shaft, a locking shaft, a tightening spring, a hoisting arm, a pressure arm, a top shoe, a bottom shoe, a top bearing, and a bottom bearing;
Whereby the male shaft is a long rod with several holes in its upper part;
Whereby the bottom of the male shaft is attached to the bottom bearing, which in turn is attached to the bottom shoe;
Whereby the female shaft is a long, hollow rod with a bottom opening and a top opening; whereby the upper part of the female shaft has a stopper and an external support means and its bottom part has a locking hole;
Whereby the locking shaft is a short rod whose upper end is attached to the top bearing, which in turn is attached to the top shoe; and whereby the bottom end of the locking shaft is attached to the said spring.
